(19) United States
(12) Patent Application Publication
(10) Pub. No.: US 2015/0348080 A1
(43) Pub. Date: Dec. 3, 2015

(54) OMNI CHANNEL COMMERCE ENHANCEMENT MECHANISMS

(71) Applicant: Bank of America Corporation, Charlotte, NC (US)

(72) Inventors: Leslie R. McNamara, Charlotte, NC (US); Dean L. Henry, Charlotte, NC (US); Matthew R. Leavenworth, Charlotte, NC (US)

(21) Appl. No.: 14/478,064

(22) Filed: Sep. 5, 2014

Related U.S. Application Data
(60) Provisional application No. 62/004,988, filed on May 30, 2014.

(51) Int. Cl. G06Q 30/02; G06Q 20/10

(52) U.S. Cl. CPC G06Q 30/0222; G06Q 30/0215; G06Q 20/10

(57) ABSTRACT

A method for providing an electronic platform for redeeming a customer benefit offer is provided. The platform may include a receiver and one or more processors. The method may use the processor to establish a consumer packaged goods (“CPG”) treasury account. The method may use the receiver to receive a designation of a customer funding instrument. The method may further use the receiver to receive the transaction data. The transaction data may include a purchasing record of one or more purchased items. The method may further use the receiver to receive bar code information related to one of the purchased items. The method may further use the processor to determine whether the transaction data and the bar code data qualify an existent customer benefit offer for redemption. In response to a determination that the transaction data and the bar code data qualify an existent customer benefit offer for redemption, the method may further include executing a transfer of funds from the CPG treasury account to the customer funding instrument. The transfer may correspond, at least in part, to the amount of the customer benefit offer.

### CROSS REFERENCE TO RELATED APPLICATION

This application is a non-provisional application of U.S. Provisional Application No. 62/004,988 entitled “OMNI-CHANNEL COMMERCE ENHANCEMENT MECHANISMS”, filed on May 30, 2014.

### FIELD OF TECHNOLOGY

The disclosure relates to mechanisms for enhancing omni-channel commerce. Specifically, this disclosure relates to mechanisms for deepening relationships with customers who use traditional and digital shopping channels.

### BACKGROUND OF THE DISCLOSURE

For the purposes of this disclosure, the term “omni-channel” may be understood to refer to a shopping experience for a customer who uses traditional and digital shopping channels, at times simultaneously.

Consumer packaged goods providers (“CPGs”) face certain challenges associated with omni-channel shopping experiences. In order to respond to these challenges, CPGs are developing omni-channel commerce solutions to engage customers. Certain CPGs are seeking direct consumer engagement to increase loyalty and gain insights into individual customer needs.

It would be desirable to provide a platform to a CPG for supporting direct consumer engagement where the CPG may directly interface with the consumer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows another illustrative apparatus in accordance with the principles of the invention;

FIG. 3 shows various solutions for presentation to omni-channel customers;

FIG. 4 shows a schematic diagram of conflicting entity motivations;

FIG. 5 shows an illustrative flow chart in accordance with the invention; and

FIG. 6 shows digital coupon solution options according to certain embodiments.

### DETAILED DESCRIPTION OF THE DISCLOSURE

Systems and methods for providing a platform for supporting direct consumer engagement where the CPG may directly interface with the consumer are provided. Specifically, embodiments relate to a digital customer benefit offer distribution platform that allows a CPG to directly interface with consumers. Such a platform may preferably enable a CPG to leverage promotional resources in order to establish and/or deepen digital relationships with consumers.

Omni-channel commerce presents certain challenges for CPGs. First, customers are difficult to engage in digital environments at least because of the fragmentation of the on/off-line mobile and other digital mediums. Second, customers often shift from one channel, such as an on-line mobile channel, to another channel, such as a brick-and-mortar channel, which makes it difficult to track customer behavior. Third, the growth of online commerce has compressed margins at least in part because customers have instant access to competitive pricing information and e-commerce alternatives. Finally, attracting/retaining repeat customers is critical and may involve integrating the on-line and off-line commerce experience.

Certain embodiments of an electronic platform configured to redeem a customer benefit offer are provided. The platform may include a processor for establishing a consumer packaged goods (“CPG”) treasury account. The platform may also include a receiver for receiving a designation of a customer funding instrument.

The receiver may also be used to receive transaction data. The transaction data may include a purchasing record of one or more purchased items. The receiver may also be used to receive bar code information related to one of the purchased items.

The processor may be used to determine whether the transaction data and the bar code data qualify an existent customer benefit offer for redemption. In response to a determination that the transaction data and the bar code data qualify an existent customer benefit offer for redemption, the processor may execute a transfer of funds from the CPG treasury account to the customer funding instrument. The transfer may include the amount of the customer benefit offer.

It should be noted that the transaction data may relate to a product other than the product specified in the customer benefit offer. It should be noted the customer benefit offer may relate to more than one product on the purchasing record.

The processor may be further configured to store the transaction data in a memory.

Some embodiments may include a transmitter for transmitting promotional information and/or a second customer benefit offer for a product other than the product specified in the customer benefit offer.

The purchasing record may include time of purchase. The purchasing record may include date of purchase. The purchasing record may include location of purchase. The purchasing record may include cashier responsible for purchase. The purchasing record may include warranty information and/or a return policy for return of at least one of the items purchased. Using at least one of date of purchase, time of purchase and location of purchase, certain embodiments may analyze a customer purchasing tendency related to at least one purchased item.

Certain electronic platforms may include using the receiver to receive bar code information located on a customer benefit offer related to one of the purchased items. Such embodiments may include using the processor to determine whether the transaction data and the bar code data qualify the customer benefit offer for redemption at least because one of the purchase items is specified in the customer benefit offer and the date of purchase is prior to an expiration date of the customer benefit offer. Such embodiments, or other embodiments may, in response to a determination that the transaction data and the bar code data qualify an existent customer benefit offer for redemption, execute a transfer of funds from the CPG treasury account to the customer funding instrument. The transfer may correspond, at least in part, to the amount of the customer benefit offer.

In certain embodiments, a mobile communication device equipped with a scanner may be used to receive the transaction data. The transaction data may include a purchasing record of one or more purchased items. The purchasing record may specify a date of purchase. Such embodiments may include using the device to operate in combination with the scanner to receive bar code information located on a customer benefit offer related to one of the purchased items. Such embodiments may further include using the processor to determine whether the transaction data and the bar code data qualify the customer benefit offer for redemption at least because one of the purchase items is specified in the customer benefit offer and the date of purchase is prior to an expiration date of the customer benefit offer. In response to a determination that the transaction data and the bar code data qualify an existent customer benefit offer for redemption, certain embodiments may execute a transfer of funds from the CPG treasury account to the customer funding instrument. Such a transfer may correspond, at least in part, to the amount of the customer benefit offer.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

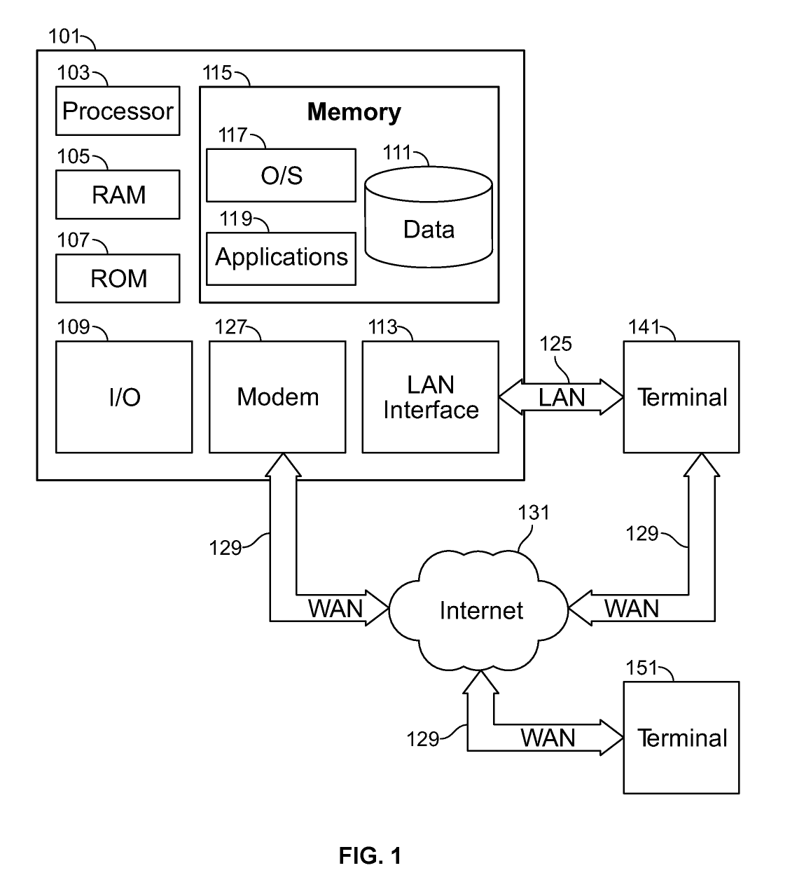

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for transferring information input into one or more of the database(s) described herein, as well as merchant information, CPG information, customer benefit offer (referred to herein, in the alternative, as a “coupon”) information, customer information, redemption information, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

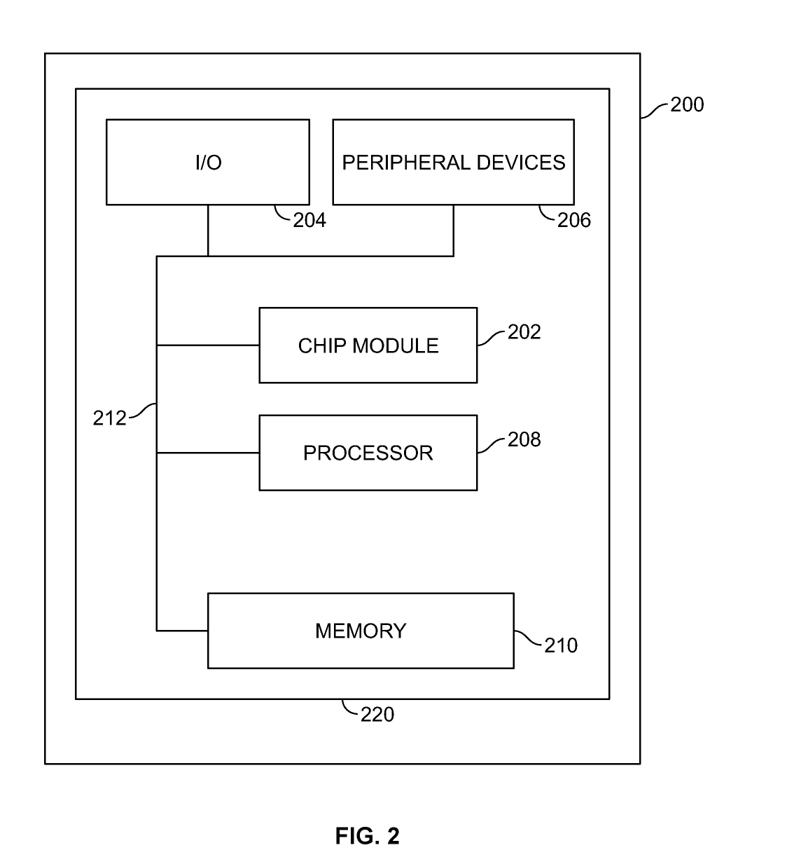

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data, quantify indices; and machine-readable memory 210.

Machine-readable memory 210 may be configured to store in machine-readable data structures: CPG information, financial institution (“FI”) information, customer benefit offer information; customer information and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

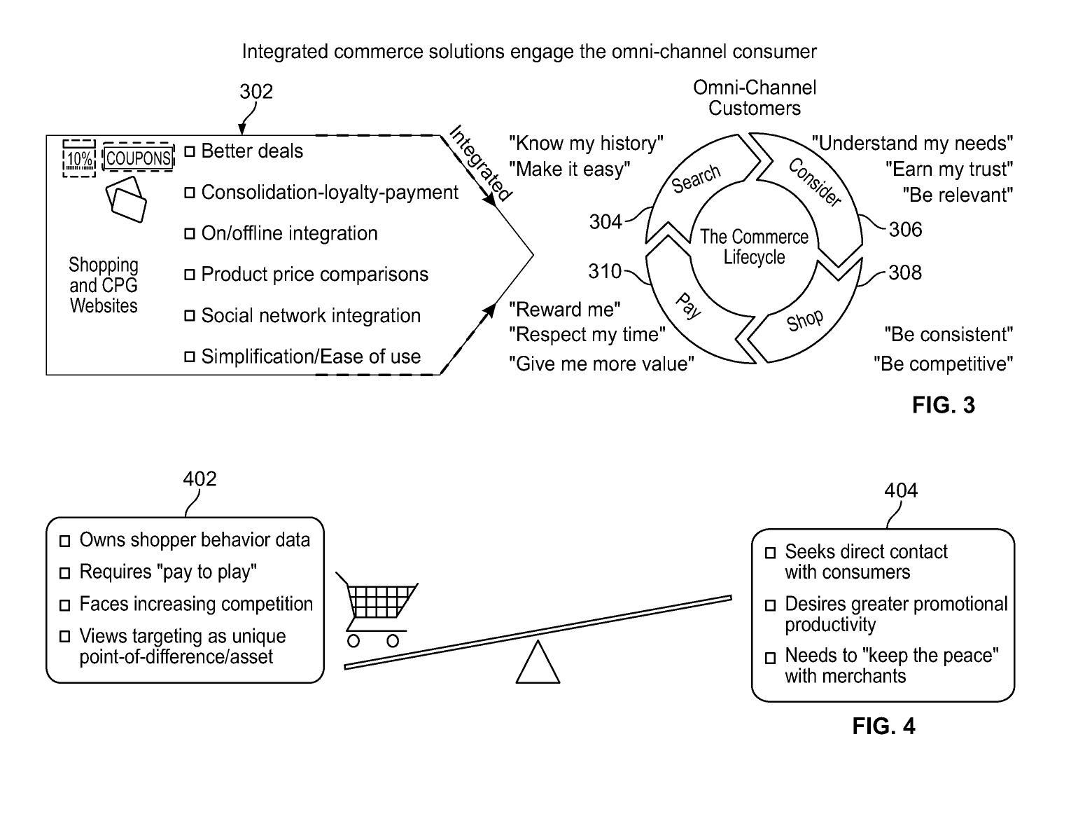

FIG. 3 shows how integrated commerce solutions engage the omni-channel consumer. CPGs may provide integrated solutions 302 to customers. Such integrated solutions 302 may include providing the customer with better deals, consolidation for loyal customers and payments thereto, integrating on-line and off-line approaches, supporting product price comparisons, social network integration and/or simplification of on-line shopping experiences.

Omni-channel customers may have needs when they search for goods and/or services. For example, they may want the CPG to know the customer's history and/or simplify the customer's search for certain goods, as shown in 304. Customers may also want CPGs (and/or merchants) to consider their respective needs, earn their respective trust and present relevant options, as shown in 306. Customers may also want to purchase from a CPG (and/or shop at a merchant) that is consistent and competitive, as shown in 308.

In some instances, CPGs are responding to omni-channel customer needs by developing omni-channel commerce solutions to facilitate direct customer engagement. Some CPGs engage the customer through omni-channel interaction. Such interaction may create opportunities for CPGs to build a direct, personal and profitable relationship with the customer. Moreover, omni-channel customers who shop in-store, through mobile applications (hereinafter, in the alternative, “app”) and online spend, on the average, six times as much as the average in-store customer.

Furthermore, obtaining preferably closed-loop data from POS payments enables CPGs (and/or merchants) to more accurately focus on, and enhance, loyalty and reward solutions. In addition, targeted offers, discounts and loyalty appreciation encourage store visits. Certain CPGs (and/or merchants) have provided omni-channel customers closed-loop payment/loyalty solutions by either rewarding in-store purchases through reward points delivered to mobile apps, or providing benefits associated with a closed-loop credit and/or debit card such as a merchant-branded credit or debit card.

From the foregoing, it has been shown that CPGs are seeking direct consumer engagement to increase loyalty and improve insights about individual consumer needs. In the past, most CPGs have depended on merchants for distribution of products and rarely engage directly with the end consumer. However, this places a burden on the CPG, as follows.

FIG. 4 illustrates the tension between the merchant and the CPG. As shown in 402, the merchant typically owns the shopper behavior data, requires “pay to play”—i.e., payment by CPGs interested in obtaining some or all of the data—, faces increasing competition and is, therefore, more willing to aggressively price goods and/or services and views consumer targeting as a point-of-difference asset that distinguishes them from the other merchants and/or other entities. The CPG, on the other hand, seeks direct contact with consumers at least in order to build the brand, desires greater promotional productivity—i.e., want more return on promotional investment—, yet needs to maintain status quo with the merchants at least for the sake of product line continuity, as shown in 404.

In such an environment, CPGs struggle to effectively leverage payments data and the existing omni-channel consumer platforms to target and engage consumers with relevant offers. However, because merchants capture transaction level purchase detail that CPGs cannot, CPGs understanding of consumer purchasing behavior/trends is limited. In fact, studies have shown that CPGs distribute about 300 million dollars face value of customer benefit offers annually, but less than 1% of the customer benefit offers are redeemed. Furthermore, consumers attribute lack of relevant offerings as the primary reason for not using a customer benefit offer.

Understandably, CPGs desire greater promotional productivity. On average, 20% of a CPG company's annual sales are allocated to consumer marketing. Such companies spent 17.25 B on direct consumer marketing in 2012. Thus, CPGs seek direct consumer engagement to gain further consumer insights and to offset their inferior position vis-à-vis merchants with respect to consumer purchasing behavior/trends.

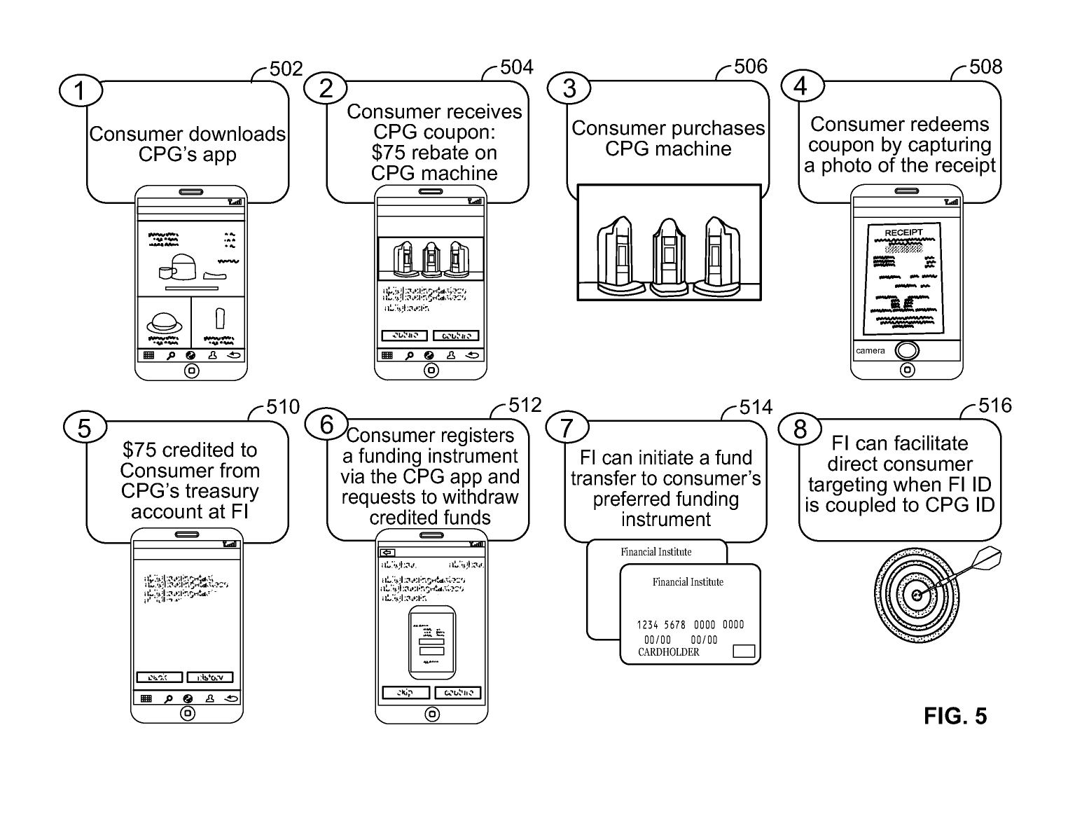

FIG. 5 shows an exemplary method for establishing a platform for CPG/consumer interaction. Some embodiments of the method shown in FIG. 5 relate to enabling and supporting a digital coupon distribution platform where CPGs directly interface with consumers. Digital coupon distribution enables CPGs to optimize spending toward driving loyalty, preventing revenue loss and encouraging brand consumption raising brand awareness. Some embodiments may include more or less than all the steps shown in FIG. 5.

The steps shown in FIG. 5 may be implemented using an app downloaded to a mobile customer device, such as the mobile customer devices described herein, or with any other suitable device and/or method.

Step 502 shows a consumer downloading a CPG app.

Step 504 shows a consumer receiving a $75.00 preferably CPG-sponsored, preferably merchant-agnostic, coupon for a coffee machine. The coupon may be a paper coupon, an electronic coupon, or other suitable coupon.

Step 506 shows that the consumer purchases the machine. The consumer may obtain a receipt showing proof of purchase. The receipt may be a paper receipt. The receipt may be an electronic receipt. The electronic receipt may be transmitted to, and stored on, a mobile device. The electronic receipt may be viewed at a later time on the mobile device.

Step 508 shows that a consumer may redeem a coupon. Step 508 shows that a consumer redeem a coupon by taking a photograph of a receipt (and/or the bar code on the item). Such a photograph may be taken with a mobile device equipped with a camera.

At least a portion of the characters in such a photograph may then be recognized. Such recognized characters may be used to obtain purchase information regarding the purchase of the coffee machine. Such purchase information may be transmitted to the CPG. Such purchase information may include purchase date, time of purchase, location of purchase, cashier, model number, SKU number, warranty information and/or any other relevant purchase information.

In certain embodiments, such purchase information may be used for analytics associated with the purchased item. For example, the CPG may aggregate various discrete pieces, or groups, of purchase information to determine trends associated with the purchaser. Such trends may reveal purchaser tendencies regarding purchase of CPG products.

In an exemplary embodiment, a CPG may aggregate information from coupon redemptions regarding the purchase of packaged coffee. Such a purchase may occur on the order of once a month or other suitable time period. Such a purchase may occur at the beginning of the month when funds may be available for such a monthly purchase. In such a circumstance, the trend derived from the coupon redemption information may preferably enable the CPG to coordinate its coupon distribution based on the needs and practices of the purchaser.

Furthermore, such information may preferably enable a CPG to perform more detailed analysis of trends for individual purchasers and also for pre-determined groups of purchasers. Such groups may be defined by location. Such groups may be defined by age. Such groups may be defined by gender. Such groups may be defined by location of purchase. Such groups may be defined as having shopped at a particular cashier. Such groups may be defined by any suitable combination of two or more of the foregoing metrics.

In some embodiments, a consumer may redeem a coupon by giving permission or otherwise allowing a direct data feed from the merchant to the CPG.

In response to receiving the transmission of the coupon information to the CPG, the CPG, or an FI administering the transfer, may then credit the consumer the face value of the coupon, $75.00, as shown in step 510.

More specifically, the CPG's treasury account, which may be resident at the FI, may directly credit a funding instrument designated and/or registered by the consumer, as shown in step 510. The designation of the funding instrument may be implemented via a computer application associated with the CPG that is installed on the customer mobile device. Such a computer application may preferably enable the customer to designate one or more of a checking account, a savings account, a direct deposit account (“DDA”), a credit card account, a retirement account or any other suitable account. Such a funding instrument may preferably allow a customer to withdraw the credited funds, as also shown in step 512.

Step 514 shows that the CPG, or the FI, initiates a fund transfer to the consumer's preferred designated funding instrument. Such a funds transfer may be executed via known transfer mechanisms including, but not limited to, Automated Clearinghouse (“ACH”), wire transfer, paper check, other suitable funds transfer, etc. Such a funds transfer may be executed for preferably any account location, whether domestic or international.

Step 516 shows that the FI can facilitate direct consumer targeting when the customer identification (“ID”) information is coupled to the CPG ID, as follows. In one exemplary scenario, the customer may be identifiable to the FI at least with a preferably FI-issued financial instrument. The financial instrument may be a credit card. The financial instrument may be a debit card. The financial instrument may be a DDA.

In certain embodiments, a database may be maintained by the CPG alone, or in combination with the FI. Such a database may preferably support coupon redemption. Such support may include allowing redemption to occur when warranted and restricting redemption from occurring when not warranted. For example, such a database may preferably restrict double redemption of coupons or other disallowed redemption strategies.

In some scenarios, the customer may also be registered at the CPG with a profile that includes a financial instrument, such as a financial instrument that the customer used on previous occasions to purchase goods from the CPG. Accordingly, a search may be performed on the CPG records to determine whether a CPG database includes financial instrument information relating to financial instruments issued by the FI. In such exemplary circumstances, the FI may use information from the CPG regarding the customer to complement its own information regarding the customer in order to help the CPG more accurately and efficiently target promotional information to the customer. Thus, coupling FI information and CPG information may enrich the knowledge base of the FI regarding the customer in a way that directly benefits the CPG. Alternative arrangements for sharing the coupled knowledge are also considered and are within the scope of the present disclosure.

A CPG may preferably use such a system to leverage promotional spend to establish and/or deepen digital relationships with consumers. The CPG can further access heretofore difficult-to-access transaction level detail via the receipt capture. Such information may allow the CPG to increase relevance of future preferably customer-specific, offers. In some embodiments, the FI may work together with the CPG and/or the merchant to leverage the captured transaction level detail in combination with already-existent information to provide the best advice possible for use by the CPG in administering its promotional spend. In certain embodiments, the merchants provide an electronic data feed of the transaction level detail to the FI to help administer coupon redemption and to collaborate with the CPG in improving accuracy and efficiency of promotional spend.

In such embodiments, the CPG can realize more effective use of promotional spend, driven by increased redemption rates and increased consumer engagement. Furthermore, digital coupon redemption rates average 15× traditional print coupon rates.

Also, such embodiments may be fully customizable to meet the CPG's needs. In certain instances, all of the transaction level detail, whether related to the CPG's products or competitor's products may be harvested for further investigation and action. For example, the transaction level detail may reveal that the customer purchased a competitor's product and the CPG may then target the customer with promotional information and/or customer benefit offers regarding the CPG's own product that competes with the previously-purchased product.

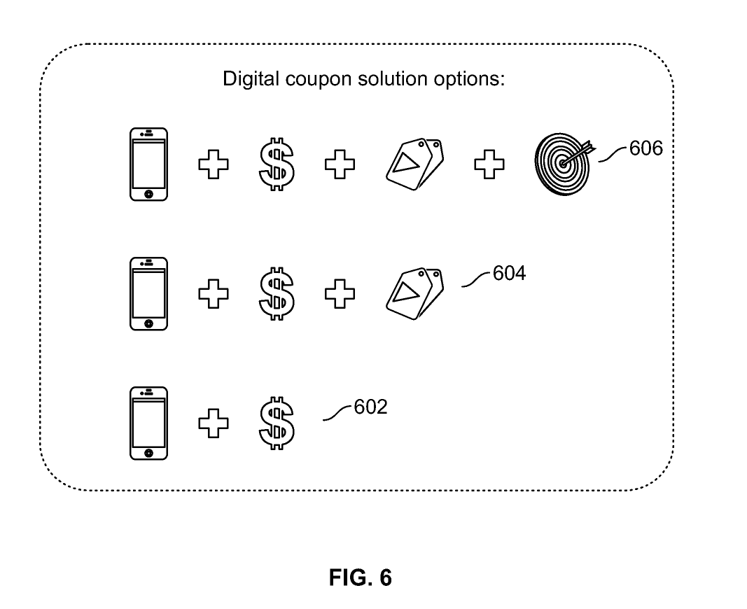

FIG. 6 shows that such a digital coupon solution may include a number of different embodiments. Embodiments may include an electronic platform that provides a mobile application and additional revenue for the CPG, as shown in 602. In some embodiments of such a platform, the FI establishes a treasury account funded by the CPG to enable the CPG to rebate customers following customer benefit offer redemption. Then the FI can execute money movement from the CPG treasury account to the consumer's preferred funding instrument for both customers of the FI and non-customers of the FI. Such a solution may preferably operate in any country in which the FI operates and/or has affiliates.

Embodiments may include an electronic platform that provides a mobile application, additional revenue and a coupon distribution channel, as shown in 604. In such embodiments, the FI can help provide insights into trends in purchase behavior to enable the CPG to deliver a more personalized experience. Such trends may be based on aggregated shopping patterns, timing and preferences to help the CPG customize the consumer experience. Such insight may also include information regarding setting of discount levels required to impact behavior.

Furthermore, the FI can help the CPG target FI customers based on the FI information regarding customers' shopping behavior. For example, the CPG can target FI customers based on their transaction history, FI-product use frequency, spending levels and merchant categories. In addition, the FI can also help the CPG establish “consumers who purchased xxx also purchased . . . ”-type targeting. This type of collaboration between the FI and the CPG may also drive FI-instrument usage which, in itself, may increase and improve consumer targeting.

Embodiments may include an electronic platform that provides a mobile application, additional revenue, a coupon distribution channel and pathways to leverage transaction data based on consumer's preference and past purchase, as shown in 606. At least some of the transaction data used in 606 may be derived from the receipt provided by the customer.

In such embodiments, an FI customer may log on to an online FI portal and select a “customer benefit offers” tab. The customer may select a CPG offer to “download an application and earn extra coupon and/or extra coupon value.” The customer may download the CPG application and register an FI funding instrument—e.g., a DDA, a debit card account, a credit card account, etc. Then one or more digital customer benefit offers may be presented to the customer. The customer may redeem the coupon by purchasing the item and capturing an image of the receipt via the application. It should be noted that the FI may also obtain and store additional information located on the receipt such as other items purchased by the customer, the cost of the items purchased, the financial instrument used to pay for the items and the location and/or time and date of the purchase. Once the receipt is verified, the enhanced coupon value may be pushed to the consumer's preferred funding instrument via the preferably FI-controlled process. Following verification and funds-push, the customer may preferably be notified by electronic transmission that the coupon has been verified and the funds associated therewith have been pushed.

Thus, methods and apparatus for providing omni-channel commerce enhancement mechanisms have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. An article of manufacture comprising a non-transitory computer usable medium having computer readable program code embodied therein, the code when executed by one or more processors for configuring a computer to execute a method for providing an electronic platform for redeeming a customer benefit offer, a method for using the platform comprising:
using a processor to establish a consumer packaged goods (“CPG”) treasury account;
using a receiver to receive a designation of a customer funding instrument;
using a receiver to receive transaction data, the transaction data comprising a purchasing record of one or more purchased items;
using the receiver to receive bar code information related to a customer benefit offer for one or more of the purchased items;
using the processor to determine whether the transaction data and the bar code data qualify an existent customer benefit offer for redemption; and
in response to a determination that the transaction data and the bar code data qualify an existent customer benefit offer for redemption, executing a transfer of funds from the CPG treasury account to the customer funding instrument, said transfer corresponding, at least in part, to the amount of the customer benefit offer.

2. The method of claim 1, wherein the transaction data relates to a product other than the product specified in the customer benefit offer.

3. The method of claim 2, further comprising storing the transaction data.

4. The method of claim 3, further comprising transmitting promotional information and/or a second customer benefit offer for a product other than the product specified in the customer benefit offer.

5. The method of claim 1 wherein the purchasing record comprises at least one of time of purchase, date of purchase, location of purchase and cashier responsible for purchase.

6. The method of claim 1 wherein the purchasing record comprises warranty information and/or a return policy for return of at least one of the items purchased.

7. The method of claim 1 method further comprises using at least one of date of purchase, time of purchase and location of purchase to analyze a customer purchasing tendency related to at least one purchased item.

8. An article of manufacture comprising a non-transitory computer usable medium having computer readable program code embodied therein, the code when executed by one or more processors for configuring a computer to execute a method for providing an electronic platform for redeeming a customer benefit offer, a method for using the platform comprising:
using a processor to establish a consumer packaged goods (“CPG”) treasury account;
using a receiver to receive a designation of a customer funding instrument;
using a receiver to receive transaction data, the transaction data comprising a purchasing record of one or more purchased items, said purchasing record specifying a date of purchase;
using the receiver to receive bar code information located on a customer benefit offer related to one of the purchased items;
using the processor to determine whether the transaction data and the bar code data qualify the customer benefit offer for redemption at least because one of the purchase items is specified in the customer benefit offer and the date of purchase is prior to an expiration date of the customer benefit offer; and
in response to a determination that the transaction data and the bar code data qualify an existent customer benefit offer for redemption, executing a transfer of funds from the CPG treasury account to the customer funding instrument, said transfer corresponding, at least in part, to the amount of the customer benefit offer.

9. The method of claim 8, wherein the transaction data relates to a product other than the product specified in the customer benefit offer.

10. The method of claim 9, further comprising storing the transaction data.

11. The method of claim 10, further comprising transmitting promotional information and/or a second customer benefit offer for a product other than the product specified in the customer benefit offer.

12. The method of claim 8 wherein the purchasing record comprises at least one of time of purchase, location of purchase and cashier responsible for purchase.

13. The method of claim 8 wherein the purchasing record comprises warranty information and/or a return policy for return of at least one of the items purchased.

14. The method of claim 8 further comprising using at least one of date of purchase, time of purchase and location of purchase to analyze a customer purchasing tendency related to at least one purchased item.

15. An article of manufacture comprising a non-transitory computer usable medium having computer readable program code embodied therein, the code when executed by one or more processors for configuring a computer to execute a method for providing an electronic platform for redeeming a customer benefit offer, a method for using the platform comprising:
using a processor to establish a consumer packaged goods (“CPG”) treasury account;
using a receiver to receive a designation of a customer funding instrument;
using a mobile communication device equipped with a scanner to receive transaction data, the transaction data comprising a purchasing record of one or more purchased items, said purchasing record specifying a date of purchase;
using the device to operate in combination with the scanner to receive bar code information located on a customer benefit offer related to one of the purchased items;
using the processor to determine whether the transaction data and the bar code data qualify the customer benefit offer for redemption at least because one of the purchase items is specified in the customer benefit offer and the date of purchase is prior to an expiration date of the customer benefit offer; and
in response to a determination that the transaction data and the bar code data qualify an existent customer benefit offer for redemption, executing a transfer of funds from the CPG treasury account to the customer funding instrument, said transfer corresponding, at least in part, to the amount of the customer benefit offer.

16. The method of claim 15, wherein the transaction data relates to a product other than the product specified in the customer benefit offer.

17. The method of claim 16, further comprising storing the transaction data.

18. The method of claim 17, further comprising using the processor, in combination with a transmitter, to transmit promotional information and/or a second customer benefit offer for a product other than the product specified in the customer benefit offer.

19. The method of claim 15 wherein the purchasing record comprises at least one of time of purchase, location of purchase and cashier responsible for purchase.

20. The method of claim 15 wherein the purchasing record comprises warranty information and/or a return policy for return of at least one of the items purchased.

21. The method of claim 15 further comprising using at least one of date of purchase, time of purchase and location of purchase to analyze a customer purchasing tendency related to at least one purchased item.
